(19) United States
(12) Patent Application Publication
(10) Pub. No.: US 2009/0035567 A1
(43) Pub. Date: Feb. 5, 2009

(54) Tacky-Adhesive and Tacky-Adhesive Sheet

(75) Inventor: Mitsunori Maruyama, Saitama (JP)

Correspondence Address: BACON & THOMAS, PLLC, 625 SLATERS LANE, FOURTH FLOOR, ALEXANDRIA, VA, 22314-1176, US

(73) Assignee: Kimoto Co., LTD., Tokyo (JP)

(21) Appl. No.: 11/922,589

(22) PCT Filed: Jun. 14, 2006
(86) PCT No.: PCT/JP2006/311917

§ 371 Date: Dec. 20, 2007

(30) Foreign Application Priority Data
Jun. 23, 2005 (JP) 2005-183432

(51) Int. Cl. B32B 7/12; C08G 59/18

(52) U.S. Cl. 428/352; 428/355 EP; 525/55

(57) ABSTRACT

The tacky-adhesive of the present invention is constituted by an acrylic resin having carboxyl group as a functional group and an acid value of 2 mg KOH/g or higher (A), an acrylic resin having hydroxyl group as a functional group and an acid value of 0.1 mg KOH/g or lower (B), an epoxy type resin (C), and a curing agent or a curing catalyst (D). The acrylic resin (B) preferably has a hydroxyl value of 5 to 100 mg KOH/g. This tacky-adhesive has superior workability for blanking and superior heat resistance, and shows superior adhesion for not only polyimide films but also polyester films. The tacky-adhesive sheet of the present invention uses this tacky-adhesive for a tacky-adhesive layer formed on a substrate.

### TECHNICAL FIELD

The present invention relates to a tacky-adhesive and tacky-adhesive sheet showing superior workability for blanking, heat resistance and adhesion.

### BACKGROUND ART

In recent years, flexible printed circuits (henceforth referred to as “FPCs”) are frequently used because of the demands for higher performance, higher functionality and smaller size of electronic equipments, and they are especially frequently used in household equipments. As adhesives and tackiness agents used for bonding substrates and copper foils, which constitute these FPCs, or bonding cover lay films or reinforcing plates and FPCs, those showing high performances for adhesion, heat resistance, workability for blanking, insulating property, bendability and so forth have come to be desired.

Adhesives are generally in the form of liquid, and applied to a substrate with a brush or roller to form an adhesive sheet, and this sheet is adhered to an adherend. The adhesives are then solidified by vaporization of solvents, polymerization reaction or the like, and thus firmly adhered on the adherend. Although such adhesives show high adhesion strength, they suffer from disadvantages concerning handling. For example, the operation for applying them on a substrate is complicated, they require a relatively long period of time for the reaction, the objects of adhesion must be fixed in some manner until the adhesives solidify, and so forth.

On the other hand, tackiness agents, which may be in the form of liquid, are generally supplied in the form of being applied on a substrate in many cases. They basically consist of a semi-solid viscoelastic material showing absorptive feeling, and have tackiness capable of bonding on adherends with weak pressure. Although they show good workability, they have a drawback that they cannot provide cohesiveness as high as that obtainable with adhesives.

In recent years, so-called “tacky-adhesives” have been proposed, which compensate these disadvantages of adhesives and tackiness agents, i.e., which can be bonded with a simple operation similar to that for tackiness agents, and are solidified in some manner after the bonding like adhesives. As such tacky-adhesives, those comprising an acrylic resin having only carboxyl groups or carboxyl groups and hydroxyl groups as functional groups, an epoxy resin, a curing catalyst, and so forth have been provided (refer to Patent document 1).

Patent document 1: Japanese Patent Unexamined Publication (KOKAI) No. 2003-313526 (claim 1)

### DISCLOSURE OF THE INVENTION

### Object to be Achieved by the Invention

If an acrylic resin having only carboxyl groups or carboxyl groups and hydroxyl groups or the like as functional groups is used as a tacky-adhesive, it shows superior workability for blanking and heat resistance as well as adhesion to polyimide films. However, this tacky-adhesive suffers from a problem of poor adhesive strength in bonding with polyester films, which results in delamination of reinforcing plates and cover lay films.

For overcoming the aforementioned problem, it has been eagerly desired to provide a tacky-adhesive and tacky-adhesive sheet showing superior workability for blanking and heat resistance as well as superior adhesion not only for polyimide films but also for polyester films.

Therefore, an object of the present invention is to provide a tacky-adhesive and tacky-adhesive sheet showing superior workability for blanking and heat resistance as well as superior adhesion not only for polyimide films but also for polyester films.

### Means for Achieving the Object

The inventors of the present invention conducted various researches in order to achieve the aforementioned object, and as a result, obtained the following findings. When an acrylic resin having only carboxyl groups as functional group was independently used as an acrylic resin component of a tacky-adhesive, the tacky-adhesive showed poor adhesive property for polyester films. It is considered that such a tacky-adhesive is not appropriately oriented on an adhesion interface with an adherend, and therefore shows poor adhesive property. This tendency was the same also for an acrylic resin having carboxyl groups and introduced with hydroxyl groups or the like, and adhesion could not be improved only by introducing hydroxyl groups.

On the other hand, when a mixture of an acrylic resin having carboxyl groups and an acrylic resin having hydroxyl groups was used as the acrylic resin component, improvement in the adhesion was observed. In particular, acid values of these two kinds of acrylic resins significantly influenced on the adhesion for polyester films and properties as tacky-adhesives, and if those having specific acid values were used, marked improvement of the characteristics could be obtained.

The present invention was accomplished on the basis of the aforementioned findings.

That is, the tacky-adhesive of the present invention is characterized by comprising an acrylic resin having carboxyl group as a functional group and an acid value of 2 mg KOH/g or higher (A), an acrylic resin having hydroxyl group as a functional group and an acid value of 0.1 mg KOH/g or lower (B), an epoxy type resin (C), and a curing agent or a curing catalyst (D).

In the tacky-adhesive of the present invention, the acrylic resin (B) preferably has a hydroxyl value of 5 to 100 mg KOH/g.

In the tacky-adhesive of the present invention, the acrylic resin (A) and/or the acrylic resin (B) preferably has a glass transition temperature of −20 to 20° C.

In the tacky-adhesive of the present invention, the acrylic resin (A) and the acrylic resin (B) are preferably contained in a ratio of 1 to 100 weight parts of the acrylic resin (B) to 100 weight parts of the acrylic resin (A).

In the tacky-adhesive of the present invention, the acrylic resin (A) and/or the acrylic resin (B) preferably has a weight average molecular weight of 300,000 to 1,200,000.

Further, the tacky-adhesive sheet of the present invention is characterized by comprising a tacky-adhesive layer consisting of the aforementioned tacky-adhesive and formed on a substrate.

In the tacky-adhesive sheet of the present invention, the substrate is preferably a cover lay film for flexible printed circuits, a reinforcing plate for flexible printed circuits, or a delaminatable substrate.

### Effect of the Invention

According to the present invention, by using an acrylic resin having carboxyl groups as functional groups and an acid value not smaller than a specific value and an acrylic resin having hydroxyl groups as functional groups and an acid value not larger than a specific value in combination for a tacky-adhesive, a tacky-adhesive showing superior workability for blanking and heat resistance as well as superior adhesion not only for polyimide films but also for polyester films can be provided. Moreover, according to the present invention, a tacky-adhesive sheet showing superior workability for blanking and heat resistance as well as superior adhesion not only for polyimide films but also for polyester films can also be provided, because the tacky-adhesive sheet is prepared by forming a layer of the aforementioned tacky-adhesive on a substrate.

### BEST MODE FOR CARRYING OUT THE INVENTION

First, embodiments of the tacky-adhesive of the present invention will be explained.

The tacky-adhesive of the present invention comprises (1) an acrylic resin having carboxyl group as a functional group and an acid value of 2 mg KOH/g or higher (A), (2) an acrylic resin having hydroxyl group as a functional group and an acid value of 0.1 mg KOH/g or lower (B), (3) an epoxy type resin (C), and (4) a curing agent or a curing catalyst (D) as essential components. These components will be each explained below.

The acrylic resin (A) has at least one or more carboxyl groups in one molecule, and is a copolymer comprising a (meth)acrylic acid ester as a main component, a vinyl monomer having carboxyl group, and acrylonitrile, styrene or the like as required. If the acrylic resin (B) mentioned later is used alone, the curing reaction occurring between the acrylic resin (B) and the epoxy type resin (C) becomes insufficient, and therefore the functions such as workability for blanking and heat resistance are degraded. However, by using this acrylic resin (A) in combination, such problems can be solved.

Examples of the (meth)acrylic acid ester include, for example, monomers such as ethyl (meth)acrylate, propyl (meth)acrylate, butyl (meth)acrylate, hexyl (meth)acrylate, octyl (meth)acrylate, 2-ethylhexyl (meth)acrylate, undecyl (meth)acrylate and lauryl (meth)acrylate, monomers having hydroxyl group such as 2-hydroxyethyl (meth)acrylate, 2-hydroxypropyl (meth)acrylate and allyl alcohol, monomers having epoxy group such as epichlorohydrin-modified products of glycidyl acrylate, dimethylaminoethyl acrylate etc., and so forth. One or more kinds of these can be selected and used.

Examples of the vinyl monomer having carboxyl group include, for example, acrylic acid, methacrylic acid, itaconic acid, crotonic acid, maleic acid, maleic anhydride and so forth, but not limited to these.

Acrylonitrile, styrene etc. as optional components can be added in order to improve the performances such as heat resistance. Although the addition amount is not particularly limited, they are preferably added in an amount of about 10% by weight or less based on the (meth)acrylic acid ester.

The acid value of the acrylic resin (A) should be 2 mg KOH/g or higher. With an acid value of 2 mg KOH/g or higher, practically usable curing reaction rate and curing temperature can be realized. The acid value can be made to be within the aforementioned range by suitably selecting the types of the monomers constituting the acrylic resin (A), and the ratio of the vinyl monomer having carboxyl group. Although the ratio of the vinyl monomer having carboxyl group to the (meth)acrylic acid ester varies depending on the types of the monomers and cannot be generally defined, it is usually 0.1% by weight or more. So long as the acrylic resin (A) has an acid value of 2 mg KOH/g or higher, it may comprise other functional groups such as hydroxyl group, epoxy group and methylol group.

The acrylic resin (A) is preferably a polymer acrylic resin having a weight average molecular weight of 300,000 to 1,200,000, more desirably 500,000 to 1,000,000, as determined by gel permeation chromatography (GPC). With a weight average molecular weight of 300,000 or more, favorable heat resistance can be obtained. Moreover, with a weight average molecular weight of 1,200,000 or less, elevation of the solution viscosity can be prevented, and problems of bad workability, bad handling property at the time of the production of the tacky-adhesive sheet and so forth can be prevented.

The acrylic resin (A) preferably has a glass transition temperature of −20 to 20° C., more desirably −20 to 10° C. With a glass transition temperature of −20° C. or higher, flow out of the tacky-adhesive at the time of heat lamination or heat pressing can be prevented. Moreover, with a glass transition temperature of 20° C. or lower, sufficient tackiness for performing temporary adhesion can be obtained. The glass transition temperature can be adjusted to be within the range mentioned above by suitably selecting the type of monomers constituting the acrylic resin (A).

Examples of the polymerization method for the acrylic resin (A) and the acrylic resin (B) mentioned later include block polymerization, solution polymerization, emulsion polymerization, suspension polymerization and so forth. However, suspension polymerization is preferred, because it does not require any salting-out step and is not easily influenced by an emulsifier which causes reduction of migration.

The acrylic resin (B) is used in order to improve adhesion to polyester films. If the aforementioned acrylic resin (A) alone is used, the functional groups of the resin such as hydroxyl groups are not appropriately oriented at the adhesion interface with the adherend, and adhesion for polyester films becomes bad. However, if the acrylic resin (B) is used in combination, the effects characteristic to the present invention, that is, superior workability for blanking and heat resistance as well as strong adhesion not only for polyimide films but also for polyester films, can be obtained.

This acrylic resin (B) is an acrylic resin having at least one or more hydroxyl groups in one molecule, and is a copolymer comprising a (meth)acrylic acid ester as a main component, a vinyl monomer having hydroxyl group, and acrylonitrile, styrene or the like as required.

Examples of the (meth)acrylic acid ester include those similar to those mentioned for the acrylic resin (A). One or more kinds of those can be selected and used.

Examples of the vinyl monomer having hydroxyl group include 2-hydroxyethyl acrylate, 2-hydroxypropyl acrylate, allyl alcohol and so forth, but not limited to these.

Acrylonitrile, styrene etc. as optional components can be added in order to improve the performances such as heat resistance. Although the addition amount is not particularly limited, they are preferably added in an amount of about 10% by weight or less based on the (meth)acrylic acid ester.

The acid value of the acrylic resin (B) should be 0.1 mg KOH/g or lower. With an acid value of 0.1 mg KOH/g or lower, adhesion for polyester films at the time of being used in combination with the acrylic resin (A) can be improved. So long as the acrylic resin (A) has an acid value of 0.1 mg KOH/g or lower, it may include other functional groups such as methylol group and epoxy group. In addition, it is more preferable to use an acrylic resin having only hydroxyl group and no free acid group such as carboxyl group (that is, the acid value is 0) in view of obtaining the effect of the present invention.

The acrylic resin (B) preferably has a hydroxyl value of 5 to 100 mg KOH/g, more preferably 5 to 50 mg KOH/g, for the hydroxyl groups contained as a functional group. With a hydroxyl value in such a range, degradation of adhesion for polyester films etc. and degradation of storage property of the tacky-adhesive due to excessive crosslinking can be prevented. The hydroxyl value can be adjusted to be within the aforementioned range by suitably selecting the types of the monomers constituting the acrylic resin (B), and the ratio of the vinyl monomer having hydroxyl group. Although the ratio of the vinyl monomer having hydroxyl group to the (meth)acrylic acid ester varies depending on the types of the monomers and cannot be generally defined, it is usually about 1 to 25% by weight.

The acrylic resin (B) is preferably a polymer acrylic resin having a weight average molecular weight of 300,000 to 1,200,000, more desirably 300,000 to 800,000, as determined by GPC, like the acrylic resin (A). With a weight average molecular weight of 300,000 or more, heat resistance can be obtained. Further, with a weight average molecular weight of 1,200,000 or less, elevation of the solution viscosity can be prevented, and problems of bad workability and bad handling property at the time of the production of the tacky-adhesive sheet and so forth can be prevented. By making both the acrylic resin (A) and the acrylic resin (B) have weight average molecular weights within the preferred ranges, the effect of the present invention can be obtained more markedly.

The acrylic resin (B) preferably has a glass transition temperature of −20 to 20° C., more desirably −15 to 15° C. With a glass transition temperature of −20° C. or higher, flow out of the tacky-adhesive at the time of heat lamination or heat pressing can be prevented. Moreover, with a glass transition temperature of 20° C. or lower, sufficient tackiness for performing temporary adhesion can be obtained. The glass transition temperature can be adjusted to be within the range mentioned above by suitably selecting the type of monomers constituting the acrylic resin (B). By making both the acrylic resin (A) and the acrylic resin (B) have glass transition temperatures within the preferred ranges, the effect of the present invention can be obtained more markedly.

The total content of the acrylic resin (A) and acrylic resin (B) in the tacky-adhesive of the present invention is preferably 50 to 98% by weight, more desirably 60 to 95% by weight, based on the total solid content of the tacky-adhesive. With a content of 50% by weight or more, flexibility of the tacky-adhesive can be maintained. With a content of 98% by weight or less, reduction of the curing reaction with the epoxy resin can be prevented.

As for the ratio the acrylic resin (A) and the acrylic resin (B) contained, it is preferable to use 1 to 100 weight parts, more preferably 5 to 80 weight parts, of the acrylic resin (B) with 100 weight parts of the acrylic resin (A). With a ratio of 1 weight part or more of the acrylic resin (B), adhesion for polyester films can be made sufficient. With a ratio of 100 weight parts or less of the acrylic resin (B), workability for blanking of the tacky-adhesive sheet can be made sufficient.

The epoxy type resin (C) may be one having two or more epoxy groups in one molecule, and includes not only polyfunctional epoxy resins, but also various resins having epoxy groups as functional groups. Although the epoxy type resin (C) is not particularly limited, examples include bisphenol A type epoxy resins, bisphenol F type epoxy resins, novolak type epoxy resins such as those of phenol novolak type, cresol novolak type and bisphenol novolak type, aliphatic epoxy resins, and so forth. These epoxy type resins can be used independently or as a combination of two or more of them.

The epoxy type resin (C) preferably has an epoxy equivalent of 150 to 1000 g/eq. With an epoxy equivalent of 150 g/eq or more, adhesion for polyester films etc. can be made effective. With an epoxy equivalent of 1000 g/eq or less, reduction of the curing reaction can be prevented, and degradation of thermosetting property can be prevented.

The content of the epoxy type resin (C) is preferably 5 to 50% by weight, more desirably 10 to 30% by weight, based on the total solid of the tacky-adhesive. With a content of 5% by weight or more, reduction of crosslinking density can be prevented, and degradation of heat resistance can be prevented. With a content of 50% by weight or less, degradation of adhesion can be prevented, and problems including flow out of the adhesive at the time of pressing can be prevented.

The curing agent or curing catalyst (D) may be a known curing agent or known curing catalyst for epoxy type resins, and it is not particularly limited. Examples include aliphatic amine type curing agents, aromatic amine type curing agents, acid anhydride type curing agents, dicyandiamide, boron trifluoride/amine complex salts, imidazole compounds, para-toluenesulfonic acid, latent acid generators and so forth. The content of the curing agent or the curing catalyst is preferably 0.1 to 20 weight parts, desirably 1 to 10 weight parts, based on 100 weight parts of the epoxy type resin (C). With a content of 0.1 weight part or more, sufficient curing reaction of the epoxy type resin (C) can be obtained, and degradation of heat resistance and electrical characteristics can be prevented. With a content of 20 weight parts or less, problems including degradation of adhesion and storage stability can be prevented.

The tacky-adhesive may be mixed with another resin, crosslinking agent, tackiness agent, acid proliferation agent, dilution solvent, filler, colorant, matting agent, lubrication enhancer, antistatic agent, flame retardant, antimicrobial agent, antifungal agent, ultraviolet absorber, light stabilizer, antioxidant, plasticizer, leveling agent, pigment dispersing agent, flow regulator, antifoaming agent and so forth, as required.

In particular, by adding a filler, heat resistance can be improved, and heat radiation property can be attained. As the filler, usually used organic or inorganic fillers can be used. A mixture of two or more kinds of these organic or inorganic fillers may also be used. As the organic fillers, various resin particles can be used, and examples include those of polymers of one or more types among styrene, vinyl ketone, acrylonitrile, methyl methacrylate, ethyl methacrylate, glycidyl methacrylate, glycidyl acrylate, methyl acrylate and so forth, those of polycondensation resins such as melamine resin and urea resin and so forth.

Examples of the inorganic fillers include, for example, metal hydroxides such as aluminum hydroxide and magnesium hydroxide, metal oxides such as aluminum oxide and calcium oxide, silica, mica, talc, clay and so forth. These can be used independently or as a combination of two or more kinds of them, as required. The content of the filler is preferably 1 to 50% by weight based on the total solid of the tacky-adhesive. With a content of 1% by weight or more, degradation of workability for blanking due to remaining viscosity on a film can be prevented. With a content of 50% by weight or less, problems including degradation of adhesion due to brittleness arising in films can be prevented.

The tacky-adhesive of the present invention is usually used as a solution of the aforementioned components dissolved in an organic solvent such as methyl ethyl ketone, toluene, methanol, N-methylpyrrolidone and N,N-dimethylformamide.

When a filler is added, it is preferable to adjust the particle diameter of the filler to be 10 μm or smaller by using a ball mill or the like. With a particle diameter of 10 μm or smaller, degradation of adhesion, heat resistance and appearance due to unevenness generated on a film surface of the tacky-adhesive sheet can be prevented.

As described above, the tacky-adhesive of the present invention uses an acrylic resin having carboxyl group as a functional group and an acid value not smaller than a specific value and an acrylic resin having hydroxyl group as a functional group and an acid value not larger than a specific value in combination, and because of this characteristic, it has superior properties of high workability for blanking and heat resistance as well as strong adhesion not only for polyimide films but also for polyester films. Therefore, the tacky-adhesive of the present invention can be suitably used for the purposes of production of FPCs and bonding of cover lay films or reinforcing plates and FPCs, which require performances including heat resistance and adhesion.

The tacky-adhesive of the present invention is used as a tacky-adhesive layer of the tacky-adhesive sheet explained below, and it can also be used by being applied to a surface of a member to be bonded or the like as same as known tackiness agents and adhesives. The tacky-adhesive of the present invention is preferably cured by heating and drying it after adhesion, and adhesion strength can be thereby improved. Although the heating method is not particularly limited, heating is preferably performed by heating with hot wind, heat pressing, or the like in a temperature range of 80 to 200° C.

Hereafter, the tacky-adhesive sheet of the present invention will be explained. The tacky-adhesive sheet of the present invention comprises a substrate and a tacky-adhesive layer formed on the substrate, and it uses the tacky-adhesive of the present invention for the tacky-adhesive layer.

The substrate has a role of a substrate for forming the tacky-adhesive layer. Although the substrate can also be used as a substrate to be delaminated at the time of use, the substrate itself can also be used as a reinforcing plate, cover lay film or the like without delaminating it.

This substrate is chosen depending on the use, and therefore it is not particularly limited. However, examples include plastic films such as polyester films, polyimide films, acrylic resin films, polyvinyl chloride films, polystyrene films, polycarbonate films, polypropylene films, triacetylcellulose films and various fluorocarbon type resin films, and so forth. As a substrate to be delaminated at the time of use, it may be, for example, a paper sheet such as a sheet of fine quality paper, Kraft paper, rolled paper, glassine paper or the like, both of which sides have a coating layer of a sealer such as clay, polyethylene and polypropylene, and are further applied with a releasing agent of silicone type, fluorine type or alkyd type on the coating layer, a polyolefin film itself selected from various polyolefin films such as polyethylene, polypropylene, ethylene/α-olefin copolymer and propylene/α-olefin copolymer films, or a film of polyethylene terephthalate or the like applied with the aforementioned releasing agent.

The tacky-adhesive sheet of the present invention can be obtained by applying a coating solution formed by dissolving the aforementioned tacky-adhesive in a suitable solvent on a substrate according to a known method such as those utilizing bar coater, blade coater, spin coater, roll coater, gravure coater, curtain coater, spray, screen printing or the like, and drying the coated solution. For improving handling property, a separator is preferably adhered on the tacky-adhesive layer.

Although the dry thickness of the tacky-adhesive sheet may be suitably changed as required, it is preferably in the range of 5 to 200 μm. With a thickness of the tacky-adhesive sheet of 5 μm or larger, sufficient adhesion strength can be obtained. With a thickness of 200 μm or smaller, insufficient drying can be prevented, and problems including generation of blisters on the sheet at the time of pressing during the production of FPCs due to a lot of remaining solvent can be prevented.

Although the condition of drying is not particularly limited, the content of the remaining solvent after drying is preferably 1% or less. With a content of 1% or less, problems including generation of blisters on the sheet due to foaming of residual solvent at the time of pressing of FPCs can be prevented.

As an example of the method for use of the tacky-adhesive sheet of the present invention, for example, the tacky-adhesive layer is adhered to a reinforcing plate formed of a polyester film or the like, then the substrate is delaminated to expose the tacky-adhesive layer, and the tacky-adhesive layer is adhered to FPC so as to adhere FPC and the reinforcing plate via the tacky-adhesive layer. When they are adhered, heat pressing or a heated roll laminator is used. The temperature for this operation can be suitably adjusted within the range of from ordinary temperature to 160° C.

Subsequently, FPC and the reinforcing plate bonded via the tacky-adhesive layer are maintained in an environment such as that in a hot air circulating type oven at 80 to 200° C. for 30 to 400 minutes to cause heat curing of the tacky-adhesive layer and thereby increase the adhesion strength. Because the adhesion strength of the tacky-adhesive layer can be increased as described above, even heat of a high temperature is given to the tacky-adhesive layer, blisters and delamination are not caused as in the case of bonding them by using an acrylic resin type pressure sensitive adhesive.

The tacky-adhesive sheet of the present invention can also be used for the production of FPC and bonding a cover lay film to FPC, and it can be used under the same conditions as mentioned above. Furthermore, if a polyester film, a polyimide film or the like is used as the substrate on which the tacky-adhesive layer is formed, the substrate itself can be used as a substrate constituting FPC, cover lay film or reinforcing plate, and thus the step of delaminating the substrate in the aforementioned method for use can be omitted.

FPC referred to here is a flexible wiring board on which a circuit pattern is formed by bonding a copper foil on a substrate such as a polyester film, chemical plating or electroplating, or printing such as conductive painting, resistance painting, dielectric painting and magnetic painting. The reinforcing plate referred to here is for increasing the strength of FPC, and a polyester film or the like is used for it. The cover lay film referred to here is for protecting a surface of FPC, and a polyester film or the like is used for it like the aforementioned components.

### EXAMPLES

Hereafter, the present invention will be further explained with reference to examples. The term and symbol “part” and “%” are used on weight basis unless specifically indicated.

### 1. Preparation of Tacky-Adhesive Sheets

### Example 1

On one side of a polyester film having a thickness of 38 μm (secondary delamination substrate, E7007, Toyobo Co., Ltd.), a coating solution for tacky-adhesive layer having the following composition was applied and dried at 80° C. for 5 minutes to form a tacky-adhesive layer having a dry film thickness of 40 μm. Further, a surface of a separate film having a thickness of 38 μm (primary delamination substrate, E7006, Toyobo Co., Ltd.) subjected to a release treatment was adhered on the tacky-adhesive layer to prepare a tacky-adhesive sheet of Example 1.

<Coating solution for tacky-adhesive layer>

| | | |
|---|---|---|
| Acrylic resin having carboxyl group and | 100 | weight parts |
| hydroxyl group (A) (SG-70L, Nagase ChemteX | | |
| Corporation, solid content: 12.5%, acid | | |
| value: 5 mg KOH/g, glass transition | | |
| temperature: −17° C., weight average | | |
| molecular weight: 800,000) | | |
| Acrylic resin having only hydroxyl group (B) | 5 | weight parts |
| (AW4500H, Negami Chemical Industrial Co., Ltd., | | |
| solid content: 100%, acid value: 0 mg KOH/g, | | |
| hydroxyl value: 8.5 mg KOH/g, glass transition | | |
| temperature: −8° C., weight average | | |
| molecular weight: 320,000) | | |
| Epoxy type resin (C) (EPICLON 1050, Dainippon | 3 | weight parts |
| Ink & Chemicals, Inc., solid content: 100%, | | |
| epoxy equivalent: 450 to 500 g/eq) | | |
| Curing agent (D) (Curezol C11Z, Shikoku | 0.5 | weight part |
| Chemicals Corporation, solid content: 100%) | | |
| Methyl ethyl ketone | 30 | weight parts |

### Example 2

A tacky-adhesive sheet of Example 2 was prepared in the same manner as that of Example 1 except that the acrylic resin (B) used in the coating solution for tacky-adhesive layer of Example 1 was replaced with another acrylic resin having only hydroxyl group (B) (W-248DR, Negami Chemical Industrial Co., Ltd., solid content: 100%, acid value: 0 mg KOH/g, hydroxyl value: 8.5 mg KOH/g, glass transition temperature: 7° C., weight average molecular weight: 450,000).

### Example 3

A tacky-adhesive sheet of Example 3 was prepared in the same manner as that of Example 1 except that the amounts of the acrylic resin (B), the epoxy type resin (C) and methyl ethyl ketone used in Example 1 were changed to 10 weight parts, 4.3 weight parts and 79 weight parts, respectively.

### Example 4

A tacky-adhesive sheet of Example 4 was prepared in the same manner as that of Example 1 except that the amounts of the acrylic resin (B) and the epoxy type resin (C) used in Example 1 were changed to 0.5 weight part and 2.2 weight parts, respectively.

### Example 5

A tacky-adhesive sheet of Example 5 was prepared in the same manner as that of Example 1 except that the amounts of the acrylic resin (B) and the epoxy type resin (C) used in Example 1 were changed to 0.1 weight part and 2.1 weight parts, respectively.

### Example 6

A tacky-adhesive sheet of Example 6 was prepared in the same manner as that of Example 1 except that the amounts of the acrylic resin (B), the epoxy type resin (C) and methyl ethyl ketone used in Example 1 were changed to 13 weight parts, 4.3 weight parts and 82 weight parts, respectively.

### Comparative Example 1

A tacky-adhesive sheet of Comparative Example 1 was prepared in the same manner as that of Example 1 except that the acrylic resin (B) of Example 1 was not used, and the amount of the epoxy type resin (C) was changed to 2 weight parts.

### Comparative Example 2

A tacky-adhesive sheet of Comparative Example 2 was prepared in the same manner as that of Example 1 except that the acrylic resin (A) of Example 1 was not used, and the amounts of the acrylic resin (B), the epoxy type resin (C) and methyl ethyl ketone used in Example 1 were changed to 20 weight parts, 3.4 weight parts and 133 weight parts, respectively.

### Comparative Example 3

A tacky-adhesive sheet of Comparative Example 3 was prepared in the same manner as that of Example 1 except that the acrylic resin (A) of Example 2 was not used, and the amounts of the acrylic resin (B) and the epoxy type resin (C) used in Example 2 were changed to 20 weight parts and 2 weight parts, respectively.

The contents (part) of the materials constituting the compositions of the tacky-adhesives of the aforementioned examples and the comparative examples are shown in Table 1. Moreover, the content ratios (part) of the acrylic resin (A) and the acrylic resin (B) are shown in Table 2.

TABLE 1

| | Material (part) | | | |
|---|---|---|---|---|
| | Acrylic | Acrylic | Epoxy type | Curing |
| | resin (A) | resin (B) | resin (C) | agent (D) |
| Example 1 | 12.5 | 5.0 | 3.0 | 0.5 |
| Example 2 | 12.5 | 5.0 | 3.0 | 0.5 |
| Example 3 | 12.5 | 10.0 | 4.3 | 0.5 |
| Example 4 | 12.5 | 0.5 | 2.2 | 0.5 |
| Example 5 | 12.5 | 0.1 | 2.1 | 0.5 |
| Example 6 | 12.5 | 13.0 | 4.3 | 0.5 |
| Comparative | 12.5 | — | 2.0 | 0.5 |
| Example 1 | | | | |
| Comparative | — | 20.0 | 3.4 | 0.5 |
| Example 2 | | | | |
| Comparative | — | 20.0 | 2.0 | 0.5 |
| Example 3 | | | | |

TABLE 2

Material (part)

| | Acrylic | Acrylic |
|---|---|---|
| | resin (A) | resin (B) |
| Example 1 | 100 | 40 |
| Example 2 | 100 | 40 |
| Example 3 | 100 | 80 |
| Example 4 | 100 | 4 |
| Example 5 | 100 | 0.8 |
| Example 6 | 100 | 104 |
| Comparative | 100 | — |
| Example 1 | | |
| Comparative | | 100 |
| Example 2 | | |
| Comparative | — | 100 |
| Example 3 | | |

### 2. Evaluation

The tacky-adhesive sheets obtained in the examples and the comparative examples were evaluated as follows. The results of the evaluation are shown in Table 3.

(1) Workability for Blanking

The separate film (primary delamination substrate) was delaminated from each of the tacky-adhesive sheets obtained in the examples and the comparative examples to expose the tacky-adhesive layer, and the polyester film (secondary delamination substrate) and a rolled copper foil having a thickness of 35 μm were adhered via the tacky-adhesive layer at 40° C. Then, the polyester film (secondary delamination substrate) was delaminated to expose the tacky-adhesive layer, and a polyimide film having a thickness of 25 μm (Kapton 100 H, Du Pont-Toray Co., Ltd.), which served as a substrate of FPC, and the rolled copper foil were adhered via the tacky-adhesive layer at 40° C. Then, the laminate was maintained in a hot air circulating type oven at 150° C. for 120 minutes to attain heat curing of the tacky-adhesive layer, and test pieces were prepared.

The test pieces obtained as described above were subjected to Thomson processing (blanking). The results are indicated with “◯” when no tacky-adhesive remained on the blanking blade, “Δ” when a small amount of tacky-adhesive remained on the blanking blade, or “X” when tacky-adhesive significantly remained on the blanking blade, after the processing.

(2) Heat Resistance

A soldering heat resistance test was performed for the aforementioned test pieces according to IPC-TM-650. The results are indicated with “◯” when no blister was formed on the tacky-adhesive layer after immersion in a solder bath at 288° C. for 10 seconds, “Δ” when blisters were formed after immersion in a solder bath at 288° C., but no blister was formed after immersion in a solder bath at 260° C. for 10 seconds, or “X” when blisters were formed after immersion in a solder bath at 260° C.

(3) Adhesion

The separate film (primary delamination substrate) was delaminated from each of the tacky-adhesive sheets obtained in the examples and the comparative examples to expose the tacky-adhesive layer, and the polyester film (secondary delamination substrate) and another polyester film having a thickness of 25 μm (S-28, Toray Industries Inc.) were adhered via the tacky-adhesive layer at 40° C. Then, the polyester film used as a substrate for forming the tacky-adhesive layer (secondary delamination substrate) was delaminated to expose the tacky-adhesive layer, and the polyester film and another polyester film having a thickness of 25 μm (S-28, Toray Industries Inc.) were adhered via the tacky-adhesive layer at 40° C. Then, the laminate was maintained in a hot air circulating type oven at 150° C. for 120 minutes to attain heat curing of the tacky-adhesive layer.

180° Peel strength of the two polyester films adhered via the tacky-adhesive layer obtained as described above was measured according to JIS C6471:1995.

Further, the separate film (primary delamination substrate) was delaminated from each of the tacky-adhesive sheets obtained in the examples and the comparative examples to expose the tacky-adhesive layer, and the polyester film (secondary delamination substrate) and a polyimide film having a thickness of 25 μm (Kapton 100 H, Du Pont-Toray Co., Ltd.) were adhered via the tacky-adhesive layer at 40° C. Then, the polyester film used as a substrate for forming the tacky-adhesive layer (secondary delamination substrate) was delaminated to expose the tacky-adhesive layer, and the polyimide film and another polyimide film having a thickness of 25 μm (Kapton 100 H, Du Pont-Toray Co., Ltd.) were adhered via the tacky-adhesive layer at 40° C. Then, the laminate was maintained in a hot air circulating type oven at 150° C. for 120 minutes to attain heat curing of the tacky-adhesive layer.

180° Peel strength of the two polyimide films adhered via the tacky-adhesive layer obtained as described above was measured according to JIS C6471:1995.

TABLE 3

| | | |
|---|---|---|
| Workability | | |
| for | Heat | Adhesion (N/cm) |

| | blanking | resistance | PET | PI |
|---|---|---|---|---|
| Example 1 | ◯ | ◯ | 8.9 | 8.5 |
| Example 2 | ◯ | ◯ | 8.2 | 8.0 |
| Example 3 | ◯ | ◯ | 8.8 | 9.0 |
| Example 4 | ◯ | ◯ | 7.2 | 9.1 |
| Example 5 | ◯ | ◯ | 7.0 | 8.7 |
| Example 6 | ◯ | Δ | 9.0 | 9.2 |
| Comparative | ◯ | ◯ | 5.2 | 9.5 |
| Example 1 | | | | |
| Comparative | X | Δ | 9.6 | 11.4 |
| Example 2 | | | | |
| Comparative | Δ | X | 9.0 | 7.0 |
| Example 3 | | | | |

Because the tacky-adhesives and tacky-adhesive sheets of the examples utilized an acrylic resin having carboxyl groups as functional groups and an acid value not smaller than a specific value and an acrylic resin having carboxyl groups and hydroxyl groups as functional groups and an acid value not larger than a specific value in combination for the tacky-adhesives, they showed superior workability for blanking, heat resistance and adhesion for both polyester films and polyimide films. In particular, as for the content ratio of the acrylic resin (A) and the acrylic resin (B), since the tacky-adhesives of Examples 1 to 4 contained the acrylic resin (B) in an amount in the range of 1 to 100 weight parts with respect to 100 weight parts of the acrylic resin (A), they showed both superior workability for blanking and superior adhesion for polyester films.

On the other hand, since the tacky-adhesive and tacky-adhesive sheet of Comparative Example 1 utilized only an acrylic resin (A) having hydroxyl group etc. as functional group as in conventional tacky-adhesives and tacky-adhesive sheets, they showed poor adhesion for polyester films.

Moreover, the tacky-adhesives and tacky-adhesive sheets of Comparative Examples 2 and 3 did not contain the acrylic resin (A) used in the examples, and therefore the curing reaction of the tacky-adhesives were insufficient, and they showed poor workability for blanking and heat resistance.

Further, although not specifically described in the examples, a humidity resistance test was performed for the tacky-adhesives and the tacky-adhesive sheets obtained in the examples, and then (1) workability for blanking, (2) heat resistance, and (3) adhesion thereof were evaluated in the same manner as described above. As a result, degradation of the performances was scarcely observed for all the samples compared with those before the humidity resistance test. Therefore, it was confirmed that the tacky-adhesives and tacky-adhesive sheets of the examples also had superior humidity resistance.

1. A tacky-adhesive comprising:
(A) an acrylic resin having carboxyl group as a functional group and an acid value of 2 mg KOH/g or higher;
(B) an acrylic resin having hydroxyl group as a functional group and an acid value of 0.1 mg KOH/g or lower;
(C) an epoxy type resin; and
(D) curing agent or a curing catalyst.

2. The tacky-adhesive according to claim 1, wherein the acrylic resin (B) has a hydroxyl value of 5 to 100 mg KOH/g.

3. The tacky-adhesive according to claim 1, wherein the acrylic resin (A) and/or the acrylic resin (B) has a glass transition temperature of −20 to 20° C.

4. The tacky-adhesive according to claim 1 wherein the acrylic resin (A) and the acrylic resin (B) are contained in a ratio of 1 to 100 weight parts of the acrylic resin (B) to 100 weight parts of the acrylic resin (A).

5. The tacky-adhesive according to claim 1, wherein the acrylic resin (A) and/or the acrylic resin (B) has a weight average molecular weight of 300,000 to 1,200,000.

6. A tacky-adhesive sheet comprising a tacky-adhesive layer consisting of the tacky-adhesive according to claim 1 and formed on a substrate.

7. The tacky-adhesive sheet according to claim 6, wherein the substrate is a cover lay film for flexible printed circuits.

8. The tacky-adhesive sheet according to claim 6, wherein the substrate is a reinforcing plate for flexible printed circuits.

9. The tacky-adhesive sheet according to claim 6, wherein the substrate is a delaminatable substrate.

10. The tacky-adhesive according to claim 2, wherein the acrylic resin (A) and/or the acrylic resin (B) has a glass transition temperature of −20 to 20° C.

11. The tacky-adhesive according to claim 10, wherein the acrylic resin (A) and the acrylic resin (B) are contained in a ratio of 1 to 100 weight parts of the acrylic resin (B) to 100 weight parts of the acrylic resin (A).

12. The tacky-adhesive according to claim 11, wherein the acrylic resin (A) and/or the acrylic resin (B) has a weight average molecular weight of 300,000 to 1,200,000.

13. A tacky-adhesive sheet comprising a tacky-adhesive layer consisting of the tacky-adhesive according to claim 12 and formed on a substrate.

14. The tacky-adhesive sheet according to claim 13, wherein the substrate is a cover lay film for flexible printed circuits.

15. The tacky-adhesive sheet according to claim 13, wherein the substrate is a reinforcing plate for flexible printed circuits.

16. The tacky-adhesive sheet according to claim 13, wherein the substrate is a delaminatable substrate.

17. The tacky-adhesive according to claim 2, wherein the acrylic resin (A) and the acrylic resin (B) are contained in a ratio of 1 to 100 weight parts of the acrylic resin (B) to 100 weight parts of the acrylic resin (A).

18. The tacky-adhesive according to claim 3, wherein the acrylic resin (A) and the acrylic resin (B) are contained in a ratio of 1 to 100 weight parts of the acrylic resin (B) to 100 weight parts of the acrylic resin (A).

19. A tacky-adhesive sheet comprising a tacky-adhesive layer consisting of the tacky-adhesive according to claim 2, and formed on a substrate.

20. A tacky-adhesive sheet comprising a tacky-adhesive layer consisting of the tacky-adhesive according to claim 3, and formed on a substrate.
